(19) United States
(12) Patent Application Publication
(10) Pub. No.: US 2017/0203609 A1
(43) Pub. Date: Jul. 20, 2017

(54) PAINTBRUSH WITH HANGING MEANS

(71) Applicants: Derek R. Haskins, San Mateo, CA (US); Justin J. McGovern, San Mateo, CA (US)

(72) Inventors: Derek R. Haskins, San Mateo, CA (US); Justin J. McGovern, San Mateo, CA (US)

(21) Appl. No.: 15/411,497

(22) Filed: Jan. 20, 2017

Related U.S. Application Data
(60) Provisional application No. 62/388,209, filed on Jan. 20, 2016.

(51) Int. Cl. B44D 3/12; A46B 15/00; A46B 17/02

(52) U.S. Cl. CPC B44D 3/123; A46B 17/02; A46B 15/0097; A46B 2200/202

(57) ABSTRACT

A modified ferrule implement configured to affix a plurality of bristles to a handle to form a modified brush. A hook mechanism extends from the ferrule implement, wherein the hook mechanism is configured to secure the modified brush to a lip or edge portion of a paint bucket or container. The securing of the modified brush to the lip or edge portion of the bucket or container includes attaching the modified brush in the lip or edge portion of the paint bucket or container at different angles and balancing the modified brush when attached to the bucket or container.

### CROSS-REFERENCE TO RELATED APPLICATIONS

The present Utility patent application claims priority benefit of the U.S. provisional application for patent Ser. No. 62/388,209 entitled “PAINTBRUSH BUDDY” filed on 20 Jan. 2016 under 35 U.S.C. 119(e). The contents of this related provisional application are incorporated herein by reference for all purposes to the extent that such subject matter is not inconsistent herewith or limiting hereof.

### RELATED CO-PENDING U.S. PATENT APPLICATIONS

Not applicable.

### INCORPORATION BY REFERENCE OF SEQUENCE LISTING PROVIDED AS A TEXT FILE

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to painting tools. More particularly, certain embodiments of the invention relates to a paintbrush comprising hanging means.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. It is believed that paintbrushes have been in use since prehistoric times. Modern paintbrushes typically comprise a handle commonly constructed of wood, acrylic or other natural and/or man-made substrates, a ferrule usually constructed of ferrous or non-ferrous metals, and a set of bristles which may be manufactured from natural and/or man-made materials. The bristles are typically attached and secured to the handle by the ferrule. The ferrule is usually manufactured of a piece of thin sheet metal, which is oftentimes rectangular in shape. During the manufacturing process of the paintbrush, the ferrule is typically wrapped around the handle and bristles then secured to itself or to another ferrule section, thus securing the bristles to the handle of the paintbrush. Nails, rivets or similar fasteners are often used to fasten the ferrule to the handle.

Paintbrushes are used most commonly for applying paint, primer, varnish and other coatings to various substrates such as, but not limited to, wood, metal, plastic and other materials. While the paintbrush itself is often simple and straight forward in one respect, it is believed that there is a considerable spectrum in terms of the skill of the painter and the quality of work they perform. Perhaps one thing that differentiates a ‘good’ painter from an ‘amateur’ or otherwise less skilled painter is the level of cleanliness they are able to maintain during the paint job in question. Since paint can be difficult to clean and in some instances can cause damage to items that it inadvertently comes into contact with, one may expect that one objective while painting may be to minimize spills and drips. One means of minimizing spills and drips is to try and keep the paintbrush handle, ferrule and in effect the painter, as clean of paint as possible. Painters oftentimes try to avoid saturating the entire bristle set in paint by only dipping the bristles partially into the paint. Moreover, painters often try to avoid over-filling a paint bucket or other receptacle whenever possible, so instead of filling the paint bucket or receptacle to near-capacity, they might only fill the bucket to 20% or 30% capacity.

Paintbrushes can be inherently messy for a number of reasons, not the least of which is that oftentimes when paintbrushes are placed into a bucket of paint, there is usually nothing to secure the paintbrush or to prevent the paintbrush from falling into the paint. It is believed that it may be quite common when painting with a paintbrush that one might place the paintbrush into the paint bucket with some amount of paint in the bottom of the bucket. To the extent the brush does not move when placed in the bucket, doing so is not necessarily problematic. One may expect that movement of the paintbrush and/or the bucket, unexpected or otherwise, may cause the paintbrush to slide into the bucket of paint, thus burying all or part of the bristles, ferrule and handle in the paint. Moreover, paintbrushes can be somewhat troublesome to transport, carry, dry after cleaning, and/or store until the next use. Paintbrushes are oftentimes much longer than they are wide, have sensitive bristles the life of which depends partially on keeping shape and form, and unlike certain other hand tools they cannot be easily placed into a pocket or clipped onto a belt, or otherwise attached to a person or to other tool for convenient carrying and transportation. Additionally, the fact that when in use the bristles of a paintbrush are oftentimes saturated in paint may make it difficult to safely set the paintbrush down to tend to other things.

By way of educational background, another aspect of the related technology generally useful to be aware of is that there are some devices currently available to enable paintbrushes to be hung on other items such as paint cans or other receptacles. One such device comprises a sheet metal hook which is designed to be attached to an existing paintbrush by way of nails and/or metal ‘teeth’. Another such device may require one to drill a hole into the handle of an existing paintbrush in order to attach the device to the paintbrush. Since paintbrush handles are typically made of hard wood and many painters are amateur ‘do-it-yourselfer’ types, attempting to screw or nail a device into an existing paintbrush could cause damage to the paintbrush or injury to the user. Furthermore, attachable devices may not be compatible with different types of brushes. For example, it may be difficult to attach some such devices to paintbrush handles with a grooved design. Many current devices meant to provide means for hanging a paintbrush may be placed in a low position on the paintbrush and may get in the way when a user is gripping the paintbrush to paint, particularly when holding the paintbrush between the thumb and forefinger together with the middle finger, which is a common technique.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A through 1D illustrate an exemplary paintbrush that may be easily hung from other objects, in accordance with an embodiment of the present invention. FIG. 1A is a diagrammatic front view. FIG. 1B is a diagrammatic rear view. FIG. 1C is a diagrammatic side view, and FIG. 1D is a perspective side view;

FIG. 2 is a diagrammatic side view of an exemplary paintbrush with a hook, in accordance with an embodiment of the present invention; and

FIG. 3 is a perspective side view of an exemplary paintbrush with a hook, in accordance with an embodiment of the present invention.

FIG. 4 is a perspective side view of an exemplary hook 400, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settle law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognized in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of Claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. §112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to avoid a strict numerical boundary to the specified parameter,” see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” includes the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, are generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of, or interaction with, some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . .” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

An embodiment of the present invention may provide a device for easily hanging and/or temporarily attaching a paintbrush to the edge of a paint bucket, paint container or virtually any other object to help prevent the paintbrush from falling into paint in such receptacles or from being inadvertently dropped in general. In some applications some embodiments may also help to make a paintbrush easier to transport to, from and throughout a jobsite and to dry after cleaning and to store until the next use.

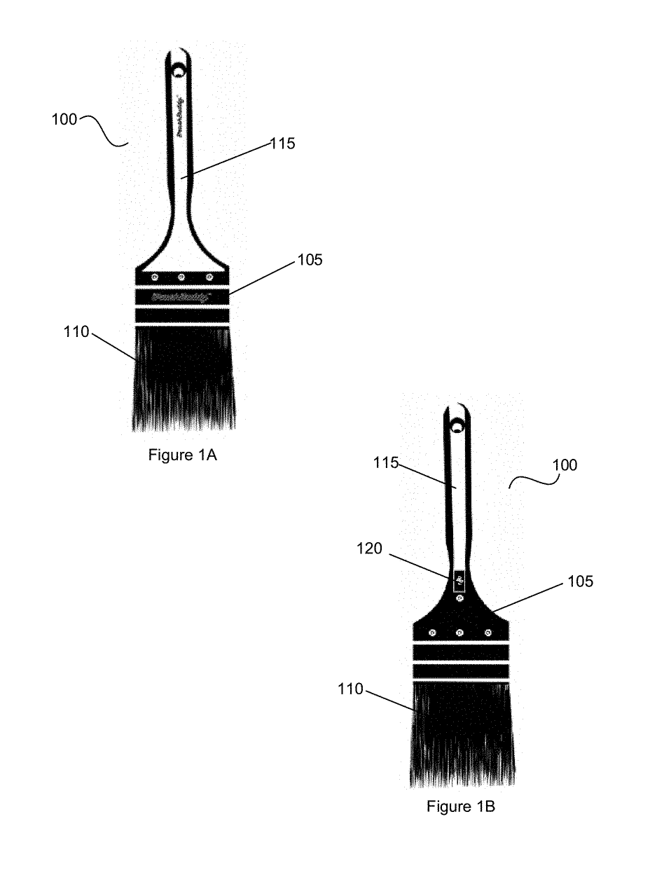

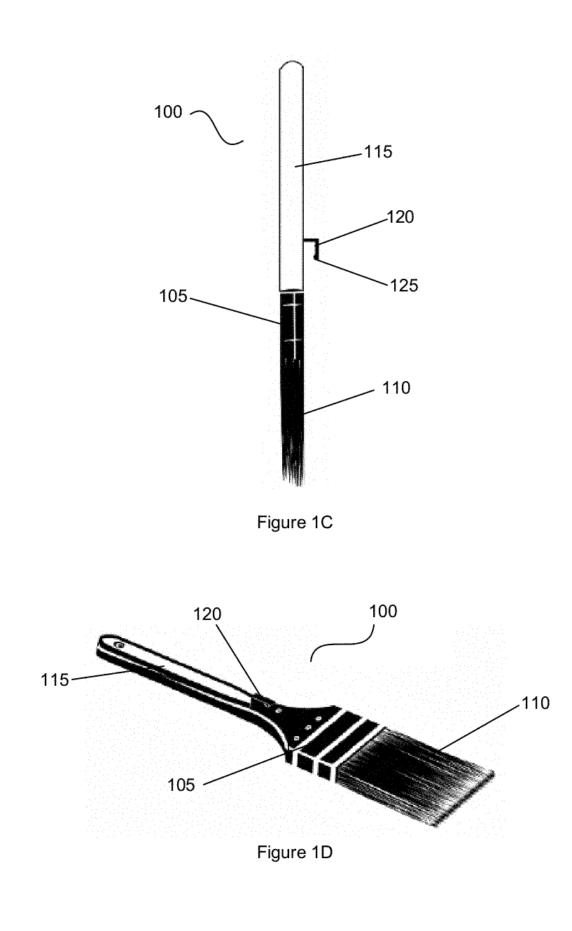

FIGS. 1A through 1D illustrate an exemplary paintbrush 100 that may be easily hung from other objects, in accordance with an embodiment of the present invention. FIG. 1A is a diagrammatic front view. FIG. 1B is a diagrammatic rear view. FIG. 1C is a diagrammatic side view, and FIG. 1D is a perspective side view. In the present embodiment, paintbrush 100 comprises a modified ferrule 105, which may also be used to affix bristles 110 to a brush handle 115. Ferrule 105 may be made of metal or plastic. Handle 115 includes a proximate top portion, a mid-portion, and a base portion. Handle 115 may be made of many different types of materials including, without limitation, wood, plastic, metal, acrylic, and flexible materials such as, but not limited to, natural or synthetic rubber. Bristles 110 may be made of natural or synthetic fibers such as, but not limited to, soft hairs, hog bristle, nylon, polyester, or a blend of materials

Referring to FIGS. 1B and 1D, on the rear surface of handle 115, ferrule 105 may extend upwards in a triangular shape which follows the shape of the base portion of handle 115. Those skilled in the art will readily recognize, in light of and in accordance with the teachings of the present invention, that the extension of the ferrule in some alternate embodiments may be implemented in shapes that do not match the shape of the handle of the paintbrush including, without limitation, narrow rectangular strips. In another embodiment, another possible configuration of the ferrule may be one that extends only partially as far up the handle as depicted in the drawings.

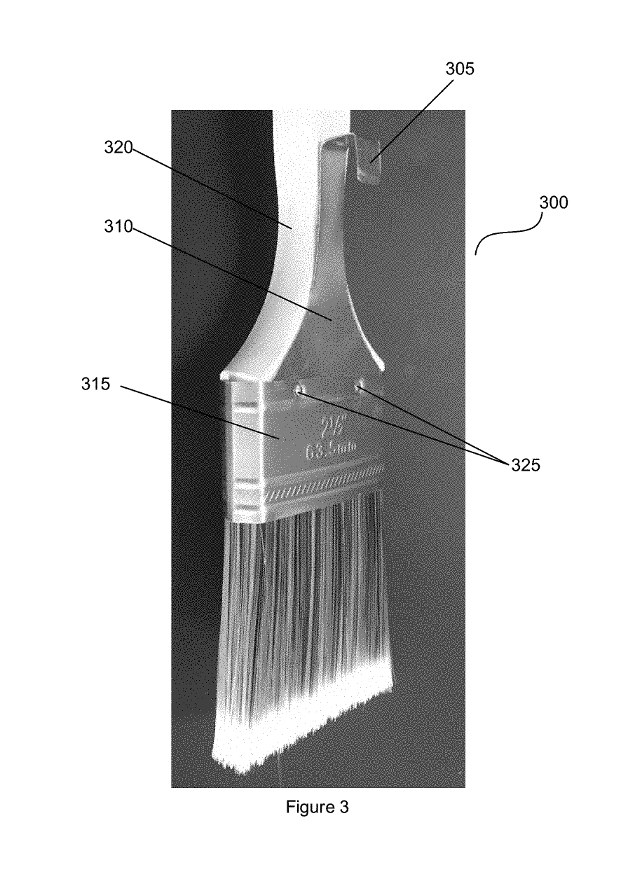

In the present embodiment, at a certain point, ferrule 105 may form a hook 120 which protrudes from handle 115 and may be used to simply and temporarily attach paintbrush 100 to any number of items such as, but not limited to, paint buckets and other paint receptacles. Referring to FIG. 1C, the bottom of hook 120 comprises a D-shaped protrusion 125 which may help secure paintbrush 100 to a paint bucket or other object. It is contemplated that hooks in some alternate embodiments may be shaped differently, for example, without limitation, hooks without barbed protrusions at the bottom, hooks with squared protrusions at the bottom, hooks with no protrusions, rounded hooks, hooks with multiple prongs, etc. Furthermore, some embodiments may comprise a hook on the front, left side or right side of the paintbrush rather than on the back of the paintbrush. Some alternate embodiments may comprise multiple extended hooks, for example, without limitation, one on the back as well as one on a side. In the present embodiment ferrule 105 and hook 120 are formed as a single piece. Other embodiments may be implemented in which the hook may be formed as a separate piece that may be attached permanently to the handle independently of the ferrule, similar to the embodiment illustrated by way of example in FIG. 3. In the present embodiment, three nails are shown on both the front and the rear of paintbrush 100 to hold ferrule 105 in place on handle 115. An additional nail is also shown immediately below hook 120 to help keep the extended portion of ferrule 105 securely attached to handle 115. Alternate embodiments may comprise more or fewer nails in a variety of configurations to maintain the attachment between the ferrule and the handle. For example, without limitation, some embodiments may comprise two nails to attach the ferrule to the brush handle, similar to the embodiment illustrated by way of example in FIG. 3. In such embodiments, a third nail may be attached to the extended portion of the ferrule near the hook. Other embodiments may comprise more than three nails attaching the ferrule to the brush handle. In embodiments comprising a nail on the extended portion of the ferrule, this nail may be located underneath the hook. It is further contemplated that some embodiments may also be implemented without a nail near the hook, similar to the embodiment illustrated by way of example in FIG. 3. Yet other alternate embodiments may use various different means of attachment other than or in addition to nails including, without limitation, screws, adhesives, bands, etc.

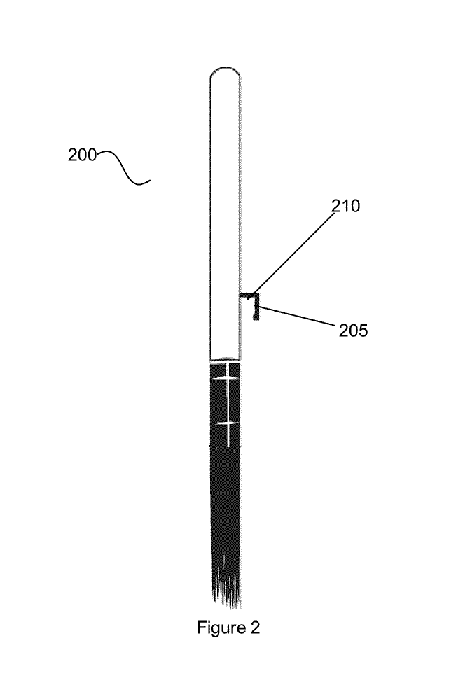

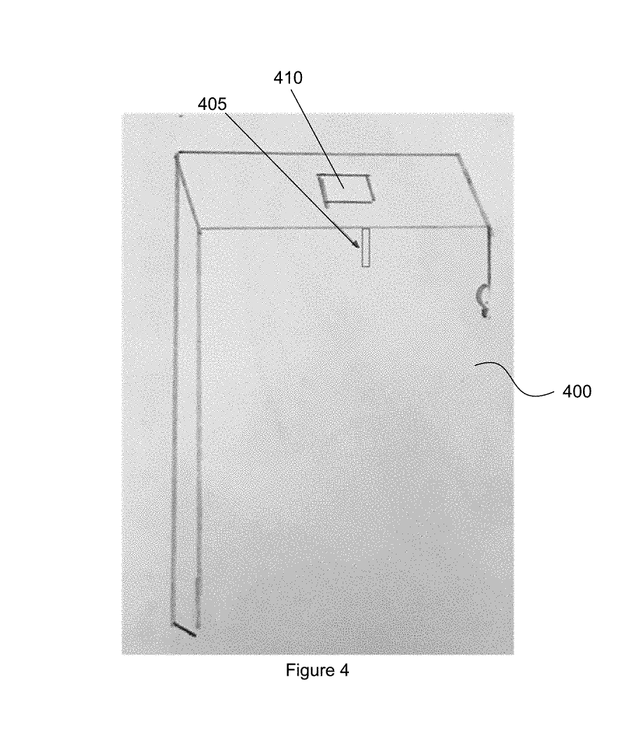

In typical use of the present embodiment, paintbrush 100 may be attached to another object by placing hook 120 over a portion of the object. For example, without limitation, paintbrush 100 may be attached to a paint bucket by placing hook 120 over the lip of the bucket. When paintbrush 100 is attached to a paint bucket or other paint receptacle, hook 120 typically securely holds paintbrush 100 in place to help prevent paintbrush 100 from falling into the paint within the receptacle. It is contemplated that paintbrush 100 may be attached to a multiplicity of suitable objects such as, but not limited to, paint cans, paint buckets of various sizes, ladders, tool cabinets, tool belts, pockets, a loop on a pair of painter's overalls or pants, drying racks, retail or point of purchase displays, etc. Hook 120 may be placed in such a location on paintbrush 100 to typically allow paintbrush 100 to be properly balanced when hanging from hook 120 to help prevent a circumstance where paintbrush 100 might be displaced from its hanging location. Moreover, hook 120 may be designed in such a way and placed in such a location on handle 115 so that when paintbrush 100 is attached to a paint bucket the section of paintbrush 100 below hook 120 may rest in the bucket at a relatively slight angle. This angle may be achieved by resting a small protrusion on the top portion of the inside of hook 120 against the object on which hook 120 is hung. Two representations of such protrusions are illustrated by way of example in FIG. 2 and FIG. 4. Moreover, some embodiments may be manufactured without a mechanism to control angle. In the present embodiment, this angle may help to prevent ferrule 105 from coming into contact with paint that might have accumulated on the inner wall of the bucket. This helps keep paintbrush 100 clean, which may help maintain the cleanliness of the jobsite and may help prolong the life of paintbrush 100. Furthermore, the placement of hook 120 and the overall design of ferrule 105 may provide an ergonomic design so as not to interfere with the grip of a user while painting, whether paintbrush 100 is being held between thumb and forefinger/middle finger or for a more standard hold where paintbrush 100 is held by the long end of handle 115. In the present embodiment, hook 120 is stationary as movement of hook 120, such as, but not limited to a swiveling movement, may cause hook 120 to be unstable. However, some alternate embodiments may comprise hooks made of a pliable material that may enable the hook to flex out of the way if the user grabs the paintbrush near the hook. In the present embodiment, hook 120 sits higher on handle 115 than traditional paint brush packaging which typically wraps around ferrule 105 and bristles 110. Therefore, this traditional type packaging should work well for paintbrush 100 with little to no modification.

FIG. 2 is a diagrammatic side view of an exemplary paintbrush 200 with a hook 205, in accordance with an embodiment of the present invention. In the present embodiment, hook 205 comprises a ridge 210 on the inside upper edge which may enable paintbrush 200 to be attached to a bucket or other object at two different angles. This may allow a user to choose an appropriate angle to help prevent unwanted paint from coming into contact with paintbrush 200. Ridge 210 may catch on the edge of the bucket to give different depths and therefore different angles as ridge 210 may allow for paintbrush 200 to be hung on the side of the bucket in multiple ways. For example, without limitation, ridge 210 may be placed so that the edge of the bucket rests between the right most section of ridge 210 and the outer portion of hook 205 providing for some sort of angle. In another configuration, paintbrush 200 may be placed so that the edge of the bucket rests between the left most section of ridge 210 and the portion of hook 205 against the handle, which would typically position paintbrush 200 in the bucket with the ferrule practically touching the inner side of the bucket. Those skilled in the art will readily recognize, in light of and in accordance with the teachings of the present invention that other embodiments may comprise a multiplicity of suitable mechanisms on the hooks to manipulate the angle of the paintbrush. For example, without limitation, some embodiments may comprise a series of notches or ridges that may enable a user to choose from multiple angles at which the paintbrush can hang. Other embodiments may comprise a protrusion that is formed by a portion of the hook that is cut out and bent into place, similar to the embodiment illustrated by way of example in FIG. 4.

FIG. 3 is a perspective side view of an exemplary paintbrush 300 with a hook 305, in accordance with an embodiment of the present invention. In the present embodiment, a hook mechanism 310 is a separate piece from a ferrule 315. In this configuration, ferrule 315 is standard in design, and hook mechanism 310 is formed to fit the shape of a handle 320. In some alternate embodiments, the shape of the hook mechanism may not match the shape of the handle. In the present embodiment, to attach hook mechanism 310 to paintbrush 300, hook mechanism may be slid underneath ferrule 315 and attached with the same two nails 325 that attach ferrule 315 to handle 320. In some embodiments another nail may be placed higher on the hook mechanism, near the hook, to further secure the hook mechanism to the handle. It is contemplated that attachment means other than nails may be used in some alternate embodiments such as, but not limited to, screws or adhesive. In the present embodiment, ferrule 315 and hook mechanism 310 may be made of the same material or different materials. For example, without limitation, in some embodiments a plastic hook mechanism could be used with a metal ferrule.

FIG. 4 is a perspective side view of an exemplary hook 400, in accordance with an embodiment of the present invention. In the present embodiment, hook 400 comprises an angle manipulating mechanism 405 that may be formed by punching a portion of hook 400 through the top of hook 405. This leaves a hole 410 in the top of hook 400 where mechanism 405 is punched through. Mechanism 405 is shown with a substantially rectangular shape; yet, other embodiments may comprise angle manipulating mechanisms in a multiplicity of suitable shapes such as, but not limited to, triangles or rounded shapes.

The embodiments in the foregoing are shown as typical commercially available paintbrushes with long, flat handles. Those skilled in the art will readily recognize, in light of and in accordance with the teachings of the present invention, that similar hook devices may be attached to various different types of paintbrushes in other embodiments such as, but not limited to, paintbrushes with short handles, paintbrushes with rounded handles, paintbrushes with grooved handles, etc. In fact, virtually any sort of brush may be configured with a hook mechanism according to an embodiment of the present invention including, without limitation, wallpaper paste brushes, toothbrushes, cleaning brushes, janitorial products, brooms, paint rollers, art brushes, industrial machine brushes, etc.

It is contemplated that some embodiments may be implemetned as a hook mechanism that may be provided separately to be attached by a user to an existing paintbrush. The separate hook mechanism may be a piece of sheet metal that is cut to a specific shape which would correspond with the shape of the particular brush handle it is being attached to, or in some instances a universal shape designed to fit most if not all standard, pre-manufactured paint brushes. In the current embodiment. It may be designed to slide behind the existing ferrule, or it may be designed to sit flush with the top edge of the existing ferrule. The separate hook mechanism may have two, three or possibly four nail holes or more for affixing the separate hook mechanism to a paint brush. The top section of the hook may be much narrower than the bottom and may extrude outward and down, forming a sheet metal hook.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing a paintbrush comprising hanging means according to the present invention will be apparent to those skilled in the art. Various aspects of the invention have been described above by way of illustration, and the specific embodiments disclosed are not intended to limit the invention to the particular forms disclosed. The particular implementation of the hanging means may vary depending upon the particular context or application. By way of example, and not limitation, the hanging means described in the foregoing were principally directed to paintbrush implementations; however, similar techniques may instead be applied to other types of tools both small and large such as, but not limited to, drywall knives, plaster trowels, mops, etc., which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

What is claimed is:

1. A device comprising:
a handle section having a proximate top portion, a mid-portion, and a base portion;
at least a plurality of bristle implements;
a ferrule implement, wherein said ferrule implement is a modified ferrule implement configured to affix said plurality of bristles to said handle to form a modified brush;
a hook mechanism extending from said ferrule implement, wherein said hook mechanism is configured to secure said modified brush to a lip or edge portion of a paint bucket or container;
wherein said securing of said modified brush to the lip or edge portion of the bucket or container comprises;
attaching said modified brush in said lip or edge portion of said bucket or container at different angles; and
balancing said modified brush when attached to said bucket or container.

2. The device of claim 1, in which an inside upper edge of said hook mechanism comprises at least a ridge portion configured to secure said modified brush to the paint bucket or container at two or more different angles.

3. The device of claim 2, wherein said ferrule implement and said hook mechanism is formed as a single piece tool.

4. The device of claim 3, in which a proximate end portion of said hook mechanism comprises a D-shaped protrusion that is configured to further secure said modified brush to the paint bucket or container.

5. The device of claim 4, in which said ferrule implement comprises at least two ferrule implements.

6. The device of claim 1, in which an inside upper edge of said hook mechanism comprises at least one notch portion configured to secure said modified brush to the paint bucket or container at various angles.

7. The device of claim 6, wherein said ferrule implement and said hook mechanism is formed as separate implements, and wherein said hook mechanism being slid behind said ferrule implement and attached with nails.

8. The device of claim 7, wherein said hook mechanism is configured to fit a shape of said proximate mid-portion of said handle section.

9. The device of claim 8, in which said handle section comprises at least one of, a wood, a plastic, a metal, an acrylic, and a flexible material.

10. The device of claim 6, in which said plurality of bristle implements comprises at least one of, a natural and synthetic fiber.

11. The device of claim 10, in which said hook mechanism further comprises at least one of, a rounded hook mechanism and a square hook mechanism.

12. The device of claim 7, in which said ferrule implement comprises a triangular shape which follows the shape of said base portion of said handle section.

13. The device of claim 1, in which a proximate end portion of said hook mechanism comprises at least two or more prongs.

14. The device of claim 4, in which said hook mechanism is configured to match said mid-portion of said handle section.

15. The device of claim 14, in which said hook mechanism further comprises an angle manipulating mechanism.

16. The device of claim 15, in which said hook mechanism further comprises a hole disposed at a proximate top portion of said hook mechanism.

17. A device comprising:
means for affixing a plurality of bristles to a handle of a modified brush;
means for attaching said modified brush to a lip, edge or side portion of a bucket or container;
means for allowing said modified brush to be hung on the lip, edge or side of said bucket in multiple ways; and
means for manipulating an attachment angle of said modified brush to the lip, edge or side of said bucket in said multiple ways.

18. The device of claim 17, wherein said affixing means and attaching means is formed as a single piece tool or separate tools.

19. A device comprising:
a handle section having a proximate top portion, a mid-portion, and a base portion;
at least a plurality of bristle implements;
a ferrule implement, wherein said ferrule implement is a modified ferrule implement configured to affix said plurality of bristles to said handle to form a modified brush;
a hook mechanism extending from said ferrule implement, wherein said hook mechanism is configured to secure said modified brush to a lip or edge portion of a paint bucket or container; and
a hole disposed at a proximate end portion of said hook mechanism.

20. The device of claim 19, wherein said securing of said modified brush to the lip or edge portion of the paint bucket or container comprising:
placing said modified brush in said bucket or container at different angles; and
balancing said modified brush when attached to the bucket or container.
